(19) United States
(12) Patent Application Publication
(10) Pub. No.: US 2011/0046250 A1
(43) Pub. Date: Feb. 24, 2011

(54) FLAME RETARDANT COMPOSITION AND FLEXIBLE POLYURETHANE FOAM PREPARED THEREWITH

(76) Inventor: Jeffrey K. Stowell, Wingdale, NY (US)

Correspondence Address: DILWORTH & BARRESE, LLP, 1000 WOODBURY ROAD, SUITE 405, WOODBURY, NY, 11797, US

(21) Appl. No.: 12/667,937

(22) PCT Filed: Jul. 2, 2008
(86) PCT No.: PCT/US08/08281

§ 371 Date: Oct. 19, 2010

Related U.S. Application Data
(60) Provisional application No. 60/958,494, filed on Jul. 6, 2007.

(51) Int. Cl. C08G 18/32; C09K 21/12

(52) U.S. Cl. 521/85; 252/609; 521/170

(57) ABSTRACT

A flame retardant composition comprises: (i) at least one flame retardant; (ii) at least one lactone stabilizer; (iii) at least one phosphite stabilizer; (iv) at least one epoxide stabilizer; and, (v) optionally, at least one stabilizer performance enhancer for lactone stabilizer (ii).

### BACKGROUND OF THE INVENTION

1. Field of the Invention

This invention relates to flame retardant compositions based on phosphate esters and to flexible polyurethane foams prepared therewith.

2. Description of the Prior Art

Flexible polyurethane foams are well known to be highly flammable. They are widely employed as cushioning or padding materials in upholstered furniture, mattresses and automotive seating, as sound insulation in vehicles and for vibration dampening generally. These and similar applications require that they contain an effective flame retardant additive such as a halogenated phosphate ester.

Flexible polyurethane foams are typically formed by reaction of a polyol and a diisocyanate employing water as a chemical blowing agent. The foam-forming reaction is highly exothermic, all the more so as the amount of water used in the production of a foam is increased.

Recently, there has been an industry trend toward the production of lower density polyurethane foams, e.g., foams having a density of not greater than about 1.4 lb/ft³. A problem in the manufacture of such foams arises as a result of the relatively large amounts of water that are needed to provide the volumes of carbon dioxide gas (via the highly exothermic reaction of water with isocyanate groups) necessary to achieve the desired low densities. The still higher exotherm associated with the use of relatively large amounts of water can cause core discoloration (referred to as “scorch”) in the resulting foams and can also result in some degradation of the polyols from which the polyurethane foams are derived and consequently some degradation in the mechanical properties of the foams.

### SUMMARY OF THE INVENTION

It has now been discovered that the effectiveness of a phosphate ester-type flame retardant for inhibiting or reducing scorch in flexible polyurethane foams can be significantly improved by the addition thereto of a flame retardant-effective amount of a flame retardant composition which comprises:
(i) at least one flame retardant;
(ii) at least one lactone stabilizer;
(iii) at least one phosphite stabilizer;
(iv) at least one epoxide stabilizer; and,
(v) optionally, at least one stabilizer performance enhancer for lactone stabilizer (ii).

Other than in the working examples or where otherwise indicated, all numbers expressing amounts of materials, properties of materials, and so forth, stated herein are to be understood as being modified in all instances by the term “about.”

Each numerical range recited herein shall be understood to include all sub-ranges within that range.

Any compound, material or substance which is expressly or implicitly disclosed herein as belonging to a group of structurally, compositionally and/or functionally related compounds, materials or substances shall be understood to include individual members of the group and all combinations thereof.

### DETAILED DESCRIPTION OF THE INVENTION

### I. The Flame Retardant Composition

Each of components (i)-(v) of the flame retardant composition of the invention and their amounts therein are hereinafter described.

### (i) Flame Retardant

The first essential component of the flame retardant composition of the present invention can be selected from among any of the known and conventional flame retardant compounds heretofore indicated for use in imparting flame retardant properties to synthetic resins in general and to flexible polyurethane foams in particular. Reference may be had in this regard to the classes of flame retardant compounds and individual species thereof disclosed, inter alia, in U.S. Pat. No. 7,138,448, the entire contents of which are incorporated by reference herein.

A preferred class of flame retardant compounds are those of the organophosphorus type, in particular, monomeric phosphate esters of the formula O═P—(OR)₃ wherein R is independently selected from alkyl, alkoxyalkyl and haloalkyl containing up to about 8 carbon atoms. Preferred are substitutents that are halogenated, e.g., chloroalkyl containing from 1 to 4 carbon atoms. Representative compounds of this type that can be used herein with generally good results include tris(chloroethyl) phosphate (TCEP), tris(chloropropyl) phosphate (TCPP), tris(dichloroisopropyl) phosphate (TDCP) and 2,2-bis(chloromethyl) trimethylene bis[bis(2-chloroethyl) phosphate] (chlorinated diphosphate or V6 type product) and their mixtures. Mixtures of different organophosphorus compounds are also contemplated, e.g., mixtures of halogenated and non-halogenated phosphate esters.

The organophosphorus flame retardant component can also be an oligomeric organophosphorus flame retardant, preferably one having a phosphorus content of not less than about 5% by weight.

Flame retardant(s) (i) will typically constitute the major amount of the flame retardant composition herein, e.g., from 75 to 99.5, and preferably from 90 to 99, weight percent thereof.

### (ii) Lactone Stabilizer

The second essential component of the flame retardant composition herein is a lactone stabilizer such as any of those heretofore employed for the stabilization of flame retardants. Suitable flame retardants include one or more lactones such as caprolactone, butyrolactone and valerolactone, indolinones such as any of those disclosed in U.S. Pat. Nos. 4,325,863 and 4,338,244, the entire contents of which are incorporated by reference herein, and benzofuranones such as any of those disclosed in aforementioned U.S. Pat. Nos. 4,325,863, and 4,338,244, and in U.S. Pat. Nos. 5,175,312, 5,308,899, 5,807,505 and 5,869,565, the entire contents of which are incorporated by reference herein.

Preferred benzofuranones are the benzofuran-2-ones. The commercially available benzofuranones Irgastab PUR 67 and Irgastab PUR 68 (Ciba Specialty Chemicals) have advantageously been used herein with good results.

The amounts of lactone stabilizer (ii) incorporated in the flame retardant composition of the invention can vary considerably depending on the particular stabilizer selected as well as the nature and amounts of the other components of the composition. Generally, the lactone stabilizer (ii) can be present in the flame retardant composition at a level of from 0.01 to 5, and preferably from 0.02 to 2, weight percent thereof.

(iii) Phosphite Stabilizer

The third essential component of the flame retardant composition of this invention is a phosphite stabilizer, e.g., any of those heretofore employed as stabilizers for flame retardant compositions. Among the useful phosphite stabilizers which can be incorporated in the flame retardant compositions herein are those described in U.S. Pat. No. 7,109,260, the entire contents of which are incorporated by reference herein.

Some useful phosphite stabilizers herein include triaryl phosphites; diaryl alkyl phosphites; aryl dialkyl phosphites; tris(nonylphenyl)phosphite; trilauryl phosphite; trioctadecyl phosphite; distearyl pentaerythritol diphosphite; tris(2,4-di-tert-butylphenyl)phosphite; diisodecyl phenyl phosphite; diisodecyl pentaerythritol diphosphite; bis(2,4-di-tert-butylphenyl)pentaerythritol diphosphite; bis(2,6-di-tert-butyl-4-methylphenyl)-pentaerythritol diphosphite; diisodecyloxypentaerythritol diphosphite; bis(2,4-di-tert-butyl-6-methylphenyl)pentaerythritol diphosphite; bis(2,4,6-tris(tert-butylphenyl)pentaerythritol diphosphite; tristearyl sorbitol triphosphite; bis(2,4-di-tert-butyl-6-methylphenyl)methyl phosphite; bis(2,4-di-tert-butyl-6-methylphenyl)ethyl phosphite; 2,2′,2″-nitrilo[triethyltris(3,3′,5,5′-tetra-tert-butyl-1,1′-biphenyl-2,2′-diyl)phosphite]; 2-ethylhexyl(3,3′,5,5′-tetra-tert-butyl-1,1′-biphenyl-2,2′-diyl)phosphite; trialkyl phosphites; and, tris(dipropyleneglycol)phosphite.

In general, phosphite stabilizer (iii) can be present in the flame retardant composition herein at a level of from 0.01 to 10, and preferably from 0.02 to 5, weight percent thereof.

### (iv) Epoxide Stabilizer

The fourth essential component of the flame retardant composition of the invention is an epoxide stabilizer. Preferred epoxide stabilizers have an epoxide equivalent weight of not greater than 500, more preferably not greater than 300 and preferably not greater than 250.

Suitable epoxide stabilizers include epoxy carboxylic acids such as epoxy stearic acid; glycidyl ethers of polyhydric alcohols and phenols such as triglycidyl glycerine, diglycidyl ether of diethylene glycol, glycidyl epoxy stearyl ether, 1,4-bis(2,3-epoxypropoxy)benzene, 4,4′-bis(2,3-epoxypropoxy) diphenyl ether, 1,8-bis(2,3-epoxypropoxy) octane, 1,4-bis-(2,3-epoxypropoxy)cyclohexane, tetraglycidyl ether of tetra (parahydroxylphenyl)ethane and 1,3-bis(4,5-epoxypentoxy) 5-chlorobenzene; the epoxy polyethers of polyhydric phenols, obtained by reacting a polyhydric phenol with a halogen-containing epoxide or dihalohydrin such as the reaction products of resorcinol, catechol, hydroquinone, methyl resorcinol or polynuclear phenols such as 2,2′-bis(4-hydroxyphenyl) propane (Bisphenol A), 2,2′-bis(4-hydroxyphenyl) butane, 4,4′-dihydroxy-benzophenone and 1,5-dihydroxy naphthalene with halogen-containing epoxides such as 3-chloro-1,2-epoxybutane, 3-chloro-1,2-epoxyoctane and epichlorohydrin; diepoxides containing two linked cyclohexane groups each of which possesses a fused epoxide ring such as 3,4-epoxycyclohexylmethyl-3,4-epoxycyclohexane carboxylate, bis(3,4-epoxy-6-methylcyclohexylmethyl adipate and 2(3,4-epoxycyclohexyl)-5,5-spiro(3,4-epoxy)cyclohexane-m-dioxane; and, the diepoxide 7-oxabicyclo[4.1.0]hept-3-ylmethyl 7-oxabicyclo[4.1.0]heptane-3-carboxylate.

The flame retardant composition can contain epoxide stabilizer (iv) at a level of from 0.01 weight percent to about 10, and preferably from about 0.02 weight percent to about 5 weight percent thereof.

### (v) Stabilizer Performance Enhancer for Lactone Stabilizer in (ii)

In some cases, it may be desirable to include one or more materials such as phenolic alkyl esters and/or arylamines that enhance the performance of the relatively expensive benzofuranone-type stabilizers thus allowing for reduction in the amount of benzofuranone stabilizer without a reduction in stabilizing effectiveness. Thus, e.g., Irgastab PUR 67 and Irgastab PUR 68 (Ciba Specialty Chemicals) both of which are stabilizer packages containing a benzofuranone-type stabilizer, are also believed to contain performance enhancing amounts of ester and amine components.

### II. Flexible Polyurethane Foam

In accordance with the present invention, there is provided a flexible polyurethane foam-forming composition which, under polyurethane foam-forming conditions, provides a flame-retardant flexible polyurethane foam, the composition comprising:
a) at least one polyol;
b) at least one polyisocyanate;
c) at least one blowing agent;
d) at least one catalyst for the polyurethane foam-forming reaction;
e) at least one flame retardant composition which comprises:
   (i) at least one flame retardant,
   (ii) at least one lactone stabilizer,
   (iii) at least one phosphite stabilizer,
   (iv) at least one epoxide stabilizer and
   (v) optionally, at least one stabilizer performance enhancer for lactone stabilizer (ii); and,
f) optionally, one or more other components.

Individual components (a)-(f) of the foregoing polyurethane foam-forming composition will now be described.

(a) Polyol

Examples of polyols which can be used include those commonly used in the production of flexible polyurethane foams such as polyether polyols, polyester polyols and polymer polyols.

Examples of polyether polyols include those with a hydroxyl value of from 25 to 70 KOHmg/g which are obtained by the random or block addition of alkylene oxides such as ethylene oxide and propylene oxide to polyfunctional polyols, amine compounds, and the like. Examples of polyfunctional polyols include glycols such as ethylene glycol and propylene glycol; triols such as glycerol and trimethylolpropane; polyols such as pentaerythritol, sorbitol and sucrose. Examples of amine compounds include ammonia, triethanolamine, ethylene diamine, diethylene triamine, aminoethyl piperazine and aniline.

Polyester polyols are compounds having terminal hydroxyl groups obtained by the polycondensation of polyfunctional carboxylic acids and polyfunctional hydroxyl compounds or the ring-opening self-condensation polymerizations of a lactone. The polyester polyols preferably have a number average molecular weight of from 500 to 10,000, and more preferably from 1000 to 5000. Examples of polyfunctional carboxylic acids include adipic acid, phthalic acid, succinic acid, azelaic acid and sebacic acid. Examples of polyfunctional hydroxy compounds include glycols such as ethylene glycol, propylene glycol, butanediol and diethylene glycol, and polyhydric alcohols such as glycerol, trimethylol propane and pentaerythritol. Examples of lactones include gamma-butyrolactone and epsilon-caprolactone.

Polymer polyols can be obtained by mixing a polyether polyol and an ethylenically unsaturated monomer, and, when necessary, adding chain transfer agents, dispersion stabilizers, and the like, to bring about the radical polymerization of the ethylenically unsaturated monomer in the presence of a radical initiator. Examples of ethylenically unsaturated monomers include monomers containing the cyano group such as acrylonitrile and methacrylonitrile; (meth)acrylic esters such as methyl (meth)acrylate, butyl (meth)acrylate, stearyl (meth)acrylate, hydroxyethyl (meth)acrylate, dimethylaminoethyl (meth)acrylate and dimethylaminopropyl (meth)acrylate; monomers containing carboxyl group such as acrylic acid, methacrylic acid, itaconic acid, maleic acid and fumaric acid; acid anhydride monomers such as maleic anhydride and itaconic anhydride; hydrocarbon compounds such as butadiene, isoprene and 1,4-pentadiene; aromatic hydrocarbon compounds such as styrene, alpha-methyl styrene, phenylstyrene and chlorostyrene; halogen-containing monomers such as vinyl chloride and vinylidene chloride; vinyl ethers such as vinyl ethyl ether and vinyl butyl ether; vinyl ketones such as vinyl ethyl ketone; vinyl esters such as vinyl acetate; acrylamides such as acrylamide, N,N-dimethylacrylamide, N-isopropylamide, N,N-dimethylaminopropyl acrylamide and methylene bisacrylamide; and methacrylamides such as N,N-dimethyl methacrylamide. Such ethylenically unsaturated monomers can be used alone or in combinations of two or more.

The aforementioned polyol components can be used alone or in combinations of two or more depending on the properties required of the flexible polyurethane foam that is to be prepared.

For example, a flexible polyurethane foam with high elasticity can be obtained when the aforementioned polyether polyol and polymer polyol are used in a proportion, based on the combined weight of the two, of from 30 to 90 weight percent of the former and from 70 to 10 weight percent of the latter, and preferably from 40 to 80 weight percent of the former and from 60 to 20 weight percent of the latter.

(b) Polyisocyanate

Examples of polyisocyanates which can be used include those having two or more isocyanate groups which have heretofore been used for making flexible polyurethane foams. Examples of such polyisocyanate compounds include aromatic polyisocyanates, aliphatic polyisocyanates and alicyclic polyisocyanates, as well as mixtures of two or more of such polyisocyanates, and modified polyisocyanates obtained by the modification of such polyisocyanates. Specific examples of such polyisocyanates are tolylene diisocyanate, diphenylmethane diisocyanate, polymethylene polyphenylene polyisocyanate (crude MDI), xylylene diisocyanate, isophorone diisocyanate and hexamethylene diisocyanate; and modified products of such polyisocyanates, such as carbodiimide-modified products, biuret-modified products, dimers and trimers. Prepolymers with terminal isocyanate groups obtained from such polyisocyanates and active hydrogen-containing compounds can also be used.

(c) Blowing Agent

As the blowing agent in the flexible polyurethane foam-forming composition of the present invention, known blowing agents heretofore used in such compositions are suitably selected according to the properties required of the foamed product.

Water is a typical example of such a blowing agent; other examples include methylene chloride, n-butane, isobutane, n-pentane, isopentane, dimethyl ether, acetone, carbon dioxide, and the like. Depending on the desired density and other properties of the foamed polyurethane, these and other blowing agents can be used alone or in combinations of two or more in a manner known in the art.

The amount of blowing agent to be used is not particularly limited but will ordinarily range from 0.1 to 40 parts by weight per 100 parts by weight of the polyol component of the foam-forming composition. Preferably, the amount of blowing agent(s) will be such as to provide a foam density of from 0.8 to 2.5 pounds per cubic foot, and preferably from 0.9 to 2.0 pounds per cubic foot.

(d) Catalyst

The flexible polyurethane foam-forming composition herein can contain any of the catalysts, and combination of catalysts, heretofore known or used for the production of polyurethane foams. Examples of useful catalysts include sodium hydroxide, sodium acetate, tertiary amines or materials which generate tertiary amines such as trimethylamine, triethylene diamine, N-methyl morpholine, N,N-dimethyl cyclohexylamine, and N,N-dimethyl aminoethanol. Also applicable are metal compounds such as hydrocarbon tin alkyl carboxylates, dibutyl tin diacetate, dibutyl tin dioctoate dibutyl tin dilaurate and stannous octoate; as well as other compounds intended to promote trimerization of the polyisocyanate such as, 2,4,6-tris(N,N-dimethylaminomethyl)phenol, 1,3,5-tris(N,N-dimethyl-3-aminopropyl)-S-hexahydrotriazine, potassium octoate, potassium acetate and catalysts such as DABCO TMR® and POLYCAT 43®.

Many other kinds of catalysts can be substituted for those listed above, if desired. The amount of catalyst used can advantageously range from 0.05 to 5 weight percent or more based on the total weight of polyol in the foam-forming mixture.

(e) Flame Retardant Compositions

Flame retardant composition (e), supra, can be incorporated into the foam-forming composition in widely varying amounts. In general, such amounts can range from 1 to 15, and preferably from 4 to 12, weight percent of the entire foam-forming composition.

(e) Optional Component(s)

In order to obtain relatively uniform distribution of the various components of the flexible polyurethane foam-forming composition and to achieve the desired formation of bubbles in the foamed polyurethane, an emulsifier and/or surfactant may be incorporated in therein. These materials are physical in their effect and are not always necessary, especially if denser foams are desired. Any of the many hundreds of conventional surfactants can be used in amounts of up to about 5 weight percent based on the weight of the total polyol component. Suitable surfactants are polydimethylsiloxane and polydimethylsiloxane polyalkylene copolymers, and the like.

It is also within the scope of the invention to incorporate one or more other optional components in the flexible polyurethane foam-forming composition where one desires to achieve a particular end result. Such components include, without limitation, adhesion promoters, antioxidants, antistatic agents, antimicrobials, dyes, heat stabilizers, light stabilizers, pigments, plasticizers, preservatives, ultraviolet stabilizers, and fillers in the customary amounts.

The following example is illustrative of the flame retardant composition of the invention:

### Example 1

The components of a flame retardant composition herein and their amounts identified below were combined to provide a substantially uniform mixture.

| | | Amount |
|---|---|---|
| Component | Description | (wt. %) |
| Flame retardant (i) | Fyrol FR-2 (tris(dichloroisopropyl) | 48.5 |
| | phosphate; TDCP) (Supresta) | |
| Flame retardant (i) | Phosflex 71B (butylated triphenyl | 48.5 |
| | phosphate) (Supresta) | |
| lactone stabilizer (ii) | Irgastab PUR 67 (a benzofuranone-type | 0.50 |
| | lactone stabilizer) (Ciba Specialty | |
| | Chemicals) | |
| phosphite stabilizer | Mark 517 (alkyl aryl phosphite) | 0.50 |
| (iii) | (Chemtura) | |
| epoxide stabilizer (iv) | D.E.R. 383 (reaction product of | 2.00 |
| | epichlorohydrin and bisphenol A | |
| | epichlorohydrin) (Dow) | |

### Comparative Examples 1-8; Example 2

A standard flexible polyurethane foam-forming reaction medium was prepared containing individual flame retardant compositions outside the scope of the invention (resulting foams: Comp. Ex. 1-8) and illustrative of the invention (resulting foam: Example 2 containing the flame retardant composition of Example 1). Following foaming, the resulting foams were evaluated for scorch, reported as “b” value, the higher numerical value correlating with a more yellow foam indicating a higher level of scorch. The results of the scorch evaluations are summarized below:

| | Flexible Polyurethane Foam | B value for 60 |
|---|---|---|
| Example | Flame Retardant Additive | min @ 181° C. |
| Comp. | TDCP with no stabilizer components | 28 |
| Ex. 1 | | |
| Comp. | Fyrol 38 (TDCP with a commercial | 31 |
| Ex. 2 | stabilizer package) | |
| Comp. | TDCP (0.50% Irgastab PUR 67) | 37 |
| Ex. 3 | | |
| Comp. | TDCP (0.50% Mark 517) | 36 |
| Ex. 4 | | |
| Comp. | TDCP (2.00% D.E.R. 383) | 29 |
| Ex. 5 | | |
| Comp. | TDCP (0.50% Irgastab PUR 67 + | 30 |
| Ex. 6 | 0.50% Mark 517) | |
| Comp. | TDCP (0.50% Irgastab PUR 67 + | 25 |
| Ex. 7 | 2.00% D.E.R. 383) | |
| Comp. | TDCP (0.50% Mark 517 + 2.00% | 24 |
| Ex. 8 | D.E.R. 383) | |
| Ex. 2 | TDCP (0.50% Irgastab PUR 67 + | 19 |
| | 0.50% Mark 517 + 2.00% D.E.R. 383) | |

As these data show, the foam of Ex. 2 possessed a significantly lower “b” value than any of the “b” values of the foams of Comp. Ex. 1-8 indicating a greater degree of effectiveness for the flame retardant composition herein.

Other embodiments of the invention will be apparent to those skilled in the art from a consideration of this specification or practice of the invention disclosed herein. It is intended that the specification and examples be considered as exemplary only, with the true scope and spirit of the invention being defined by the following claims.

1. A flame retardant composition which comprises:
at least one flame retardant;
at least one lactone stabilizer;
at least one phosphite stabilizer;
at least one epoxide stabilizer; and,
optionally, at least one stabilizer performance enhancer for lactone stabilizer (ii).

2. The flame retardant composition of claim 1 wherein flame retardant (i) includes at least one organophosphorus flame retardant.

3. The flame retardant composition of claim 1 wherein flame retardant (i) includes at least one phosphate ester flame retardant.

4. The flame retardant composition of claim 1 wherein flame retardant (i) includes at least one halogenated phosphate ester flame retardant, and optionally, at least one non-halogenated phosphate ester flame retardant.

5. The flame retardant composition of claim 1 wherein flame retardant (i) includes at least one chlorinated phosphate ester flame retardant.

6. The flame retardant composition of claim 1 wherein flame retardant (i) includes at least one chlorinated phosphate ester selected from the group consisting of tris(chloroethyl) phosphate, tris(chloropropyl) phosphate, tris(dichloroisopropyl) phosphate and 2,2-bis(chloromethyl) trimethylene bis[bis(2-chloroethyl) phosphate] and their mixtures.

7. The flame retardant composition of claim 1 wherein lactone stabilizer (ii) includes at least one benzofuran-2-one.

8. The flame retardant composition of claim 1 wherein lactone stabilizer (ii) includes at least one 3-phenyl benzofuran-2-one.

9. The flame retardant composition of claim 1 wherein phosphite stabilizer (iii) includes at least one member selected from the group consisting of triaryl phosphites, diaryl alkyl phosphites, aryl dialkyl phosphites, trialkyl phosphites and mixtures thereof.

10. The flame retardant composition of claim 1 wherein epoxide stabilizer (iv) includes at least one member selected from the group consisting of epoxy carboxylic acid; glycidyl ethers of polyhydric alcohols and phenols; epoxy polyethers of polyhydric phenols obtained by reacting a polyhydric phenol with a halogen-containing epoxide or dihalohydrin; and, diepoxides.

11. The flame retardant composition of claim 1 wherein optional lactone stabilizer performance enhancer (v) includes at least one member selected from the group consisting of phenolic alkyl ester and arylamine.

12. The flame retardant composition of claim 1 wherein flame retardant (i) includes at least one chlorinated phosphate ester; lactone stabilizer (ii) includes at least one benzofuran-2-one; phosphite stabilizer (iii) includes at least one member selected from the group consisting of triaryl phosphites, diaryl alkyl phosphites, aryl dialkyl phosphites, trialkyl phosphites and mixtures thereof; epoxide stabilizer (iv) includes at least one member selected from the group consisting of epoxy carboxylic acid; glycidyl ethers of polyhydric alcohols and phenols; epoxy polyethers of polyhydric phenols obtained by reacting a polyhydric phenol with a halogen-containing epoxide or dihalohydrin; and, diepoxides; and, optional lactone stabilizer performance enhancer (v) includes at least one member selected from the group consisting of phenolic alkyl ester and arylamine.

13. The flame retardant composition of claim 1 wherein flame retardant (i) includes at least one chlorinated phosphate ester selected from the group consisting of tris(chloroethyl) phosphate, tris(chloropropyl) phosphate, tris(dichloroisopropyl) phosphate and 2,2-bis(chloromethyl) trimethylene bis[bis(2-chloroethyl) phosphate] and their mixtures; lactone stabilizer (ii) includes at least one benzofuran-2-one; phosphite stabilizer (iii) includes at least one member selected from the group consisting of triaryl phosphites, diaryl alkyl phosphites, aryl dialkyl phosphites, trialkyl phosphites and mixtures thereof; epoxide stabilizer includes at least one member selected from the group consisting of epoxy carboxylic acid; glycidyl ethers of polyhydric alcohols and phenols; epoxy polyethers of polyhydric phenols obtained by reacting a polyhydric phenol with a halogen-containing epoxide or dihalohydrin; and, diepoxides; and, optional lactone stabilizer performance enhancer (v) includes at least one member selected from the group consisting of phenolic alkyl ester and arylamine.

14. The flame retardant composition of claim 1 comprising from 75 to 99.5 weight percent flame retardant (i); from 0.01 to 5 weight percent lactone stabilizer (ii); from 0.01 to 5 weight percent phosphite stabilizer (iii); from 0.01 to 10 weight percent epoxide stabilizer (iv); and, from 0 to 5 weight percent lactone stabilizer performance enhancer (v).

15. The flame retardant composition of claim 1 comprising from 90 to 99 weight percent flame retardant (i); from 0.02 to 2 weight percent lactone stabilizer (ii); from 0.02 to 2 weight percent phosphite stabilizer (iii); from 0.02 to 5 weight percent epoxide stabilizer (iv); and, from 0 to 2 weight percent lactone stabilizer performance enhancer (v).

16-19. (canceled)

20. A flexible polyurethane foam-forming reaction mixture which comprises:
(a) at least one polyol;
(b) at least one polyisocyanate;
(c) at least one blowing agent;
(d) at least one catalyst for the polyurethane foam-forming reaction; and,
(e) a flame retardant-effective amount of the flame retardant composition of claim 1.

21-28. (canceled)

29. The flexible polyurethane foam-forming reaction mixture of claim 20 wherein polyol (a) is a polyether diol; polyisocyanate (b) is a diisocyanate; blowing agent (c) is at least one member selected from the group consisting of water, carbon dioxide and hydrocarbon present in an amount to provide a foam density of from 0.8 to 2.5 pounds per cubic foot; and, flame retardant composition (e) is present in an amount of from 1 to 15 weight percent.

30. The flexible polyurethane foam-forming reaction mixture of claim 20 wherein polyol (a) is a polyether diol; polyisocyanate (b) is a diisocyanate; blowing agent (c) is at least one member selected from the group consisting of water, carbon dioxide and hydrocarbon present in an amount to provide a foam density from 0.9 to 2.0 pounds per cubic foot; and, flame retardant composition (e) is present in an amount of from 4 to 12 weight percent.

31-46. (canceled)

47. The flexible polyurethane foam obtained from the polyurethane foam-forming reaction mixture of claim 20.

48. The flexible polyurethane foam obtained from the polyurethane foam-forming reaction mixture of claim 29.
